(19) United States
(12) Patent Application Publication
(10) Pub. No.: US 2010/0155260 A1
(43) Pub. Date: Jun. 24, 2010

(54) MICRO-BLASTING TREATMENT FOR LEAD FRAMES

(76) Inventors: Yiu Fai Kwan, Hong Kong (CN); Tat Chi Chan, Hong Kong (CN); Chun Ho Yau, Hong Kong (CN)

Correspondence Address: OSTROLENK FABER GERB & SOFFEN, 1180 AVENUE OF THE AMERICAS, NEW YORK, NY, 100368403, US

(21) Appl. No.: 12/341,240

(22) Filed: Dec. 22, 2008

(51) Int. Cl. B23H 9/16

(52) U.S. Cl. 205/640; 216/96

(57) ABSTRACT

Method of manufacturing a lead frame wherein a bare lead frame material is immersed in a salt solution. Gas bubbles are provided in the salt solution next to the bare lead frame material such that the bubbles contact a surface of the lead frame material and pop in proximity to the bare lead frame material causing chemical reactions on the surface of the lead frame, thereby forming a plurality of dimples of irregular sizes on the surface of the lead frame.

### FIELD OF THE INVENTION

The invention relates to the treatment of lead frames for enhancing the adhesion of molding compound, in particular epoxy molding compound (EMC), to the lead frames.

### BACKGROUND AND PRIOR ART

There are several approaches during lead frame manufacturing that are implemented to promote adhesion of molding compound to the lead frame, typically using surface treatment to modify the texture of the lead frame. The purpose of such adhesion enhancement is usually for the sake of elevating the Moisture Sensitivity Level (MSL) of the overall electronic device package.

Some surface treatments include metal oxide formation, surface roughening, special plating schemes, and so on. Regarding copper lead frames with selective silver plating, brown oxide treatment has been a proven solution in the industry. However, its application to palladium pre-plated lead frames (Pd PPF) would be very costly. The market is still looking for a simple and low-cost solution to this problem of improving the Moisture Sensitivity Level of palladium pre-plated lead frames.

U.S. Pat. No. 6,197,615 entitled “Method of producing lead frame having uneven surfaces” discloses a lead frame which has inner leads, tie bars and a die pad that are formed with irregular dimples on their respective upper and lower surfaces. The irregular dimples are formed by way of mechanical surface modification by impacting suitable particle media from injection means such as nozzles. The irregular dimples formed during manufacture of the lead frame improve the bonding strength between the lead frame and the molding compound as well as between the die pad and a semiconductor device. However, this approach uses solid particles such as sand to mechanically roughen the lead frame surface. This may lead to deformation of fine features of the lead frame, such as the tie bars, by bombardment of the solid particles. It is also difficult to maintain the consistency of the roughness to satisfy strict process requirements.

Another approach is described in U.S. Pat. No. 6,849,930 entitled “Semiconductor Device with Uneven Metal Plate to Improve Adhesion to Molding Compound”. A semiconductor device is disclosed whose reliability is improved by improving the adhesion strength of a metal plate or connecting chip, a plurality of electrodes and a lead frame with a molding resin. The surface of the metal plate is roughened by etching, chemical polishing, plating, sand-blasting or the like to improve the adhesion strength to a molding resin by forming dimples that are semispherically-shaped. Nevertheless, semispherically-shaped dimples may only enhance the inter-locking mechanism with molding compound in terms of shear strength improvement, but not tensile (pulling) strength, since EMC adhesion is not strong enough. Furthermore, the dimples are provided to the metal plate, which serves as the electrical and thermal connection between the chip and the leads, but does not add to adhesion improvement for the overall lead frame material.

Yet another surface treatment approach utilizes micro-etching, which is taught in U.S. Pat. No. 7,078,809 entitled “Chemical Leadframe Roughening Process and Resulting Leadframe and Integrated Circuit Package”. A chemical lead frame roughening process is disclosed which includes cleaning and chemically micro-etching a raw copper lead frame to remove organic material and oxide material from the surface. The surface of the lead frame is then roughened using an organic and peroxide solution, resulting in a finely pitted surface morphology. The roughened lead frame is cleaned to remove organic material, and is then plated with a lead-free plating material (such as a layered plating of nickel-palladium-gold (NiPdAu)) having a reflow temperature higher than the reflow temperature of lead-based solder. The plated lead frame exhibits the desired finely pitted morphology that is believed to provide for greater bonding with the molding compound used to make a finished integrated circuit package, thereby improving the moisture sensitivity level performance of the package.

The problem is that although the surface of the lead frame is roughened by micro-etching treatment, its morphology becomes more spherical in shape after NiPdAu plating, thus degrading its adhesion strength with EMC. Therefore, it can only improve the shear locking effect, but there is no substantial tensile locking effect. As a result, adhesion of molding compound is not strong enough.

### SUMMARY OF THE INVENTION

It is thus an object of the present invention to seek to provide a chemical surface roughening process for a lead frame which offers both shear locking effect and tensile locking effect for adhering molding compound that has been molded onto the lead frame.

Accordingly, the invention provides a method of manufacturing a lead frame, comprising the steps of: providing a bare lead frame material; immersing the bare lead frame material in a salt solution; and providing gas bubbles in the salt solution next to the bare lead frame material such that the bubbles contact a surface of the lead frame material and pop in proximity to the bare lead frame material causing chemical reactions on the surface of the lead frame, thereby forming a plurality of dimples of irregular sizes on the surface of the lead frame.

It would be convenient hereinafter to describe the invention in greater detail by reference to the accompanying drawings which illustrate one preferred embodiment of the invention. The particularity of the drawings and the related description is not to be understood as superseding the generality of the broad identification of the invention as defined by the claims.

### BRIEF DESCRIPTION OF THE DRAWINGS

The present invention will be readily appreciated by reference to the detailed description of the preferred embodiments of the invention when considered with the accompanying drawings, in which:

FIG. 1 is a flowchart giving an overview of a lead frame treatment process with flood micro-blasting according to the preferred embodiment of the invention;

FIG. 2 is a flowchart giving an overview of a lead frame treatment process with flood mild micro-blasting and selective strong micro-blasting;

FIG. 3 is a flowchart giving an overview of a lead frame treatment process with selective strong micro-blasting only;

FIG. 4 is a flowchart giving an overview of a lead frame treatment process with selective mild micro-blasting only;

FIG. 5 is a cross-sectional illustration of a surface of a lead frame after performing lead frame treatment according to the preferred embodiment of the invention; and

FIG. 6 shows both shear locking and tensile locking mechanisms for adhering the molding compound to the surface of the lead frame.

### DETAILED DESCRIPTION OF THE PREFERRED EMBODIMENT OF THE INVENTION

Micro-blasting according to the preferred embodiment of the invention is a chemical drilling process, involving both chemical etching and mechanical drilling. In traditional micro-etching, “peak-to-valley” surface profiles are formed which will make the wire bonding and soldering process window narrower. Comparatively, micro-blasting introduces surface roughness by creating a “flat and holes” morphology such that the flat surface portions are more suitable for performing wire bonding and soldering, even after the etching process. The dimples which are etched have highly irregular shapes, with sizes ranging from 2 μm to 50 μm, which not only provide shear locking but also tensile locking.

The main chemical component is a sodium or potassium salt of an acid in a salt solution with a salt concentration of 1-50%, formed by reaction of sodium hydroxide or potassium hydroxide with an acid. The acid can be chosen from mineral or organic acids, or a mixture of both kinds of acid. The types of mineral acids which can be used include, without limitation, sulfuric acid, hydrochloric acid, nitric acid and phosphoric acid. Among these, sulfuric acid is most preferred. The types of organic acids which can be used include, without limitation, acetic acid, citric acid, tartaric acid, lactic acid and oxalic acid. Among these, oxalic acid is most preferred. Unlike typical etching processes, the salt solution used is not necessarily acidic, as the pH value can be maintained at between 1 and 9. The process temperature may be maintained at between 10-50° C.

The mechanical drilling aspect of the micro-blasting process will now be described. It is performed by gas bubbling. A bare lead frame material is immersed in the salt solution during gas bubbling, wherein gas bubbles are provided in the salt solution next to the bare lead frame material such that the bubbles contact the surfaces of the lead frame material and pop in proximity to the lead frame material, causing chemical reactions on the surface of the lead frame to form dimples thereon. The bubbles can be created by means of a suitable method, such as by compressed air, electrolysis, nozzle spray or jet, or ultrasonic energy in the salt solution in which the lead frame is immersed. A combination of the above bubble-creation methods may also be used. Where a nozzle is used, an outlet of the nozzle from which the bubbles emerge is preferably pointing towards the lead frame at an angle of 45-90 degrees with respect to the surface of the lead frame, larger angles closer to 90 degrees being more preferred. Furthermore, a gap between the nozzle outlet and the lead frame is preferably less than 50 mm for establishing good contact between them.

The gas in the bubbles which are formed preferably includes a certain amount of oxygen. The oxygen contained in the bubbles, which are generated together with the chemicals, impinge on the lead frame surface and initiate “scattered” and “localized” chemical reactions or blasting, thereby creating the characteristic dimple features.

The micro-blasting process can generally be classified into two types of strength: mild and strong. The difference in the following settings can affect the size and density of the dimples which are created during the process. Mild micro-blasting creates smaller and less-dense dimples, which minimizes the effect on wire bonding or solder (particularly for board mounting), and are suitable for areas such as the inner lead tips, die pad periphery and external leads of the lead frame. On the other hand, strong micro-blasting creates larger and denser dimples and is more suitable for areas of the lead frame which do not require wire bonding or soldering at all, such as the inner lead and die pad of the lead frame.

The parameters to achieve mild and strong micro-blasting respectively are preferably as follows:

| Parameters | Mild (Preferred range) | Strong (Preferred range) |
|---|---|---|
| Salt concentration | 10-25% | 20-40% |
| pH value | 5-8 | 2-6 |
| Temperature | 15-30° C. | 25-40° C. |
| Compressed gas | 2-4 bar | 3-6 bar |
| pressure | | |
| Electrolysis current | 10-50 ASD | 30-100 ASD |
| Nozzle spray or jet gas | 0.2-1.0 m/sec | 0.5-5 m/sec |
| flow rate | | |
| Ultrasonic frequency | 80-120 kHz | 25-65 kHz |
| Process time | 5-60 sec | 20-120 sec |
| Dimple Size | 2-20 μm | 5-50 μm |
| Density (surface | 5-50% | 20-80% |
| coverage) | | |

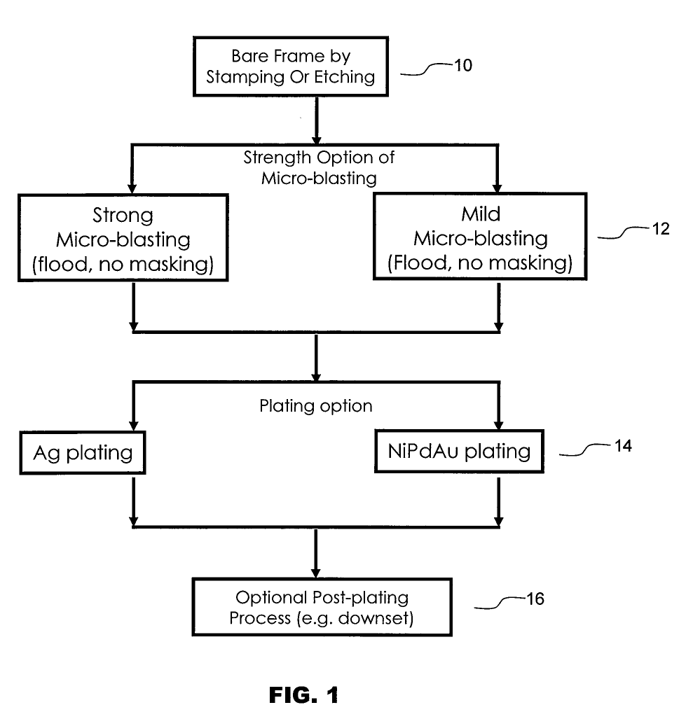

FIG. 1 is a flowchart giving an overview of a lead frame treatment process with flood micro-blasting according to the preferred embodiment of the invention. A bare lead frame is first shaped by a conventional process, which is usually either by stamping or by etching 10. Flood micro-blasting means that the lead frame is totally immersed in the salt solution without any masking. Micro-blasting (either strong or mild) is then carried out by blowing bubbles containing oxygen into the salt solution 12. The bubbles cause chemical reactions on the surface of the lead frame to form scattered dimples.

After micro-blasting, the lead frame is then plated, either by silver plating or by nickel-palladium-gold plating 14. Once plating has been completed, one or more post-plating processes may be applied to the lead frame, such as downsetting parts of the lead frame 16.

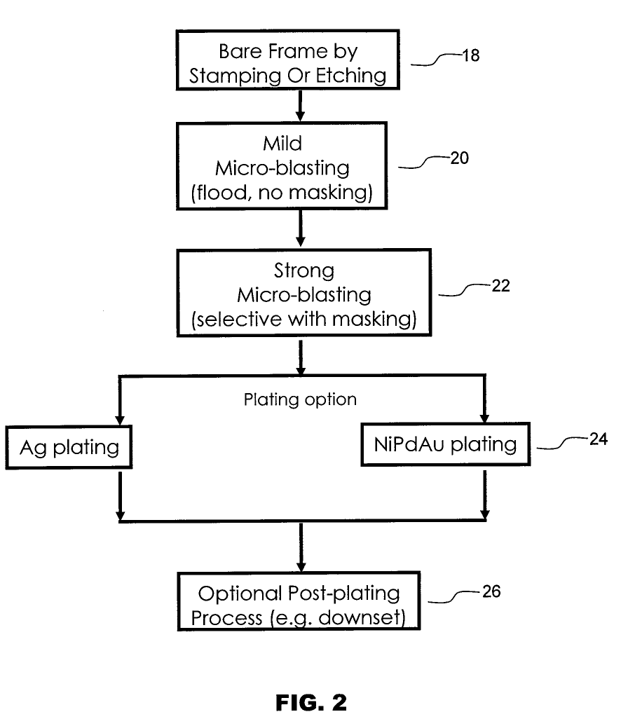

FIG. 2 is a flowchart giving an overview of a lead frame treatment process with flood mild micro-blasting and selective strong micro-blasting. A bare lead frame is first shaped by a conventional process, which is usually either by stamping or by etching 18. Mild flood micro-blasting is then carried out by blowing bubbles containing oxygen into the salt solution without masking the lead frame 20. The bubbles cause chemical reactions on the surface of the lead frame to form a first set of scattered dimples.

Thereafter, parts of the lead frame are masked, and strong selective micro-blasting is conducted 22 to form a second set of scattered dimples which have a relatively higher density and/or relatively larger sizes than the first set of dimples. Selected portions of the lead frame which do not require additional strong micro-blasting are masked and covered up so that additional dimples are not formed at the said selected portions. After said mild followed by strong micro-blasting, the lead frame is then plated with one or more layers of metallic material, either by silver plating or by nickel-palladium-gold plating 24. Once plating has been completed, one or more post-plating processes may be applied to the lead frame, such as downsetting parts of the lead frame 26.

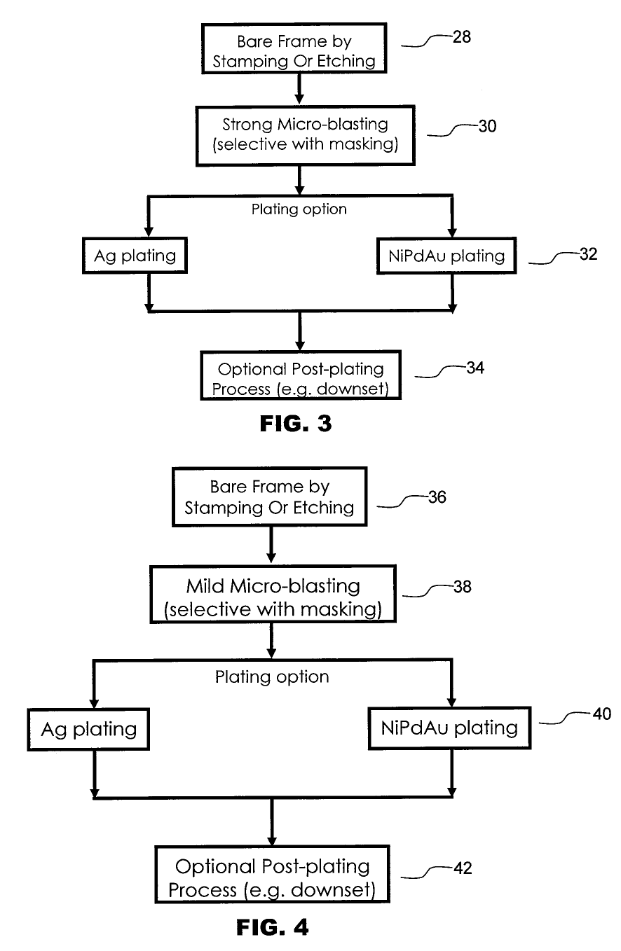

FIG. 3 is a flowchart giving an overview of a lead frame treatment process with selective strong micro-blasting only. A bare lead frame is first shaped as explained above 28. Strong selective micro-blasting is then carried out by blowing bubbles containing oxygen into the salt solution, where selected portions of the lead frame which do not require treatment are masked 30 so that dimples are not formed at the said selected portions. The bubbles cause chemical reactions on the surface of the lead frame to form scattered dimples on the unmasked areas.

After micro-blasting, the lead frame is then plated with one or more layers of metallic material, either by silver plating or by nickel-palladium-gold plating 32, followed by one or more post-plating processes, such as downsetting parts of the lead frame 34.

FIG. 4 is a flowchart giving an overview of a lead frame treatment process with selective mild micro-blasting only. A bare lead frame is first shaped as explained above 36. Mild selective micro-blasting is then carried out by blowing bubbles containing oxygen into the salt solution, where parts of the lead frame which do not require treatment are masked 38. The bubbles cause chemical reactions on the surface of the lead frame to form scattered dimples on the unmasked areas.

After micro-blasting, the lead frame is then plated with one or more layers of metallic material, either by silver plating or by nickel-palladium-gold plating 40, followed by one or more post-plating processes, such as downsetting parts of the lead frame 42.

FIG. 5 is a cross-sectional illustration of a surface of a lead frame 44 after performing lead frame treatment according to the preferred embodiment of the invention. A number of irregularly-shaped dimples 46 are scattered across the treated lead frame 44. The dimples have variable depths and widths, the scale depending on whether mild or strong micro-blasting has been applied.

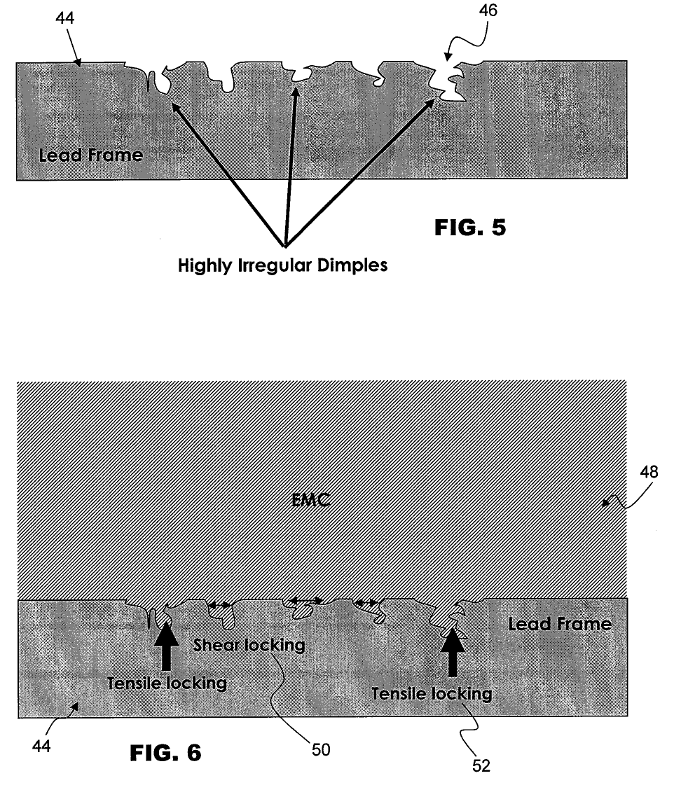

FIG. 6 shows both shear locking 50 and tensile locking 52 mechanisms for adhering molding compound in the form of EMC 48 to the surface of the lead frame 44. The fillers and resin comprised in the EMC 48 penetrate into the multiple dimples 46 spread over the surface of the lead frame 44 and become embedded and trapped inside the dimples 46. The vertically-shaped features of the dimples 46 provide shear locking 50 to prevent the EMC 48 from being dislodged by sideways forces. The horizontally-shaped features of the dimples 46 provide tensile locking 52, which prevents the EMC 48 from being dislodged by pulling forces which are perpendicular to the surface of the lead frame 44. Since the dimples 46 are shaped highly-irregularly, they provide features for both shear locking 50 and tensile locking 52 as illustrated in FIG. 6.

It should be appreciated that the highly irregular dimples formed according to the preferred embodiment of the invention can improve both shear and tensile locking with molding compound, thus giving the resulting electronic packages better performance to meet Moisture Sensitivity Level (MSL) requirements without significantly impacting on the wire bonding and soldering process windows. Comparatively, the traditional “peak-to-valley” surface profile obtained by micro-etching will make the wire bonding and soldering process windows narrower.

The process can be applied to both silver-plated lead frames as well as palladium pre-plated lead frames. Furthermore, it can be applied to both stamped and etched lead frames. While the manufacturing cost using micro-blasting is slightly lower than conventional brown oxide treatment on silver-plated lead frames, it is much lower than brown oxide treatment on palladium pre-plated lead frames, thus offering a very cost-effective solution particularly for palladium pre-plated lead frames.

The invention described herein is susceptible to variations, modifications and/or additions other than those specifically described and it is to be understood that the invention includes all such variations, modifications and/or additions which fall within the spirit and scope of the above description.

1. A method of manufacturing a lead frame, comprising the steps of:
providing a bare lead frame material;
immersing the bare lead frame material in a salt solution; and
providing gas bubbles in the salt solution next to the bare lead frame material such that the bubbles contact a surface of the lead frame material and pop in proximity to the bare lead frame material causing chemical reactions on the surface of the lead frame, thereby forming a plurality of dimples of irregular sizes on the surface of the lead frame.

2. The method as claimed in claim 1, wherein the salt solution is formed by the reaction of sodium hydroxide or potassium hydroxide with an acid.

3. The method as claimed in claim 2, wherein the acid comprises sulfuric acid.

4. The method as claimed in claim 2, wherein the acid comprises oxalic acid.

5. The method as claimed in claim 1, wherein the bubbles are formed from compressed air, electrolysis, nozzle spray or jet and/or ultrasonic energy.

6. The method as claimed in claim 1, wherein the bubbles are provided through a nozzle outlet which is pointing towards the lead frame at an angle of 45-90 degrees with respect to the surface of the lead frame.

7. The method as claimed in claim 6, wherein a gap between the nozzle outlet and the surface of the lead frame is less than 50 mm.

8. The method as claimed in claim 1, wherein the gas bubbles include oxygen gas.

9. The method as claimed in claim 1, wherein the step of providing gas bubbles to contact the bare lead frame material is carried out at a process temperature of 10-50° C.

10. The method as claimed in claim 9, wherein the process temperature is 15-40° C.

11. The method as claimed in claim 1, wherein the pH level of the salt solution is between 1 and 9.

12. The method as claimed in claim 11, wherein the pH level of the salt solution is between 2 and 8.

13. The method as claimed in claim 1, wherein the salt concentration in the salt solution is 10-40%.

14. The method as claimed in claim 1, wherein the flow rate of the bubbles is 0.2-5 m/s.

15. The method as claimed in claim 1, wherein the process time is 5-120 seconds.

16. The method as claimed in claim 1, wherein the sizes of the dimples range from 2-50 μm.

17. The method as claimed in claim 1, further comprising the step of masking selected portions of the bare lead frame material before providing bubbles to the lead frame so that dimples are not formed at the selected portions of the lead frame.

18. The method as claimed in claim 17, wherein the dimples comprise a first set of dimples and a second set of dimples, the second set of dimples having a relatively higher density than the first set of dimples, and wherein the step of providing gas bubbles further comprises the steps of forming the first set of dimples, masking selected portions of the lead frame, and thereafter forming the second set of dimples on unmasked portions of the lead frame.

19. The method as claimed in claim 17, wherein the dimples comprise a first set of dimples and a second set of dimples, the second set of dimples having relatively larger sizes than the first set of dimples, and wherein the step of providing gas bubbles further comprises the steps of forming the first set of dimples, masking selected portions of the lead frame, and thereafter forming the second set of dimples on unmasked portions of the lead frame.

20. The method as claimed in claim 1, further comprising the step of plating the lead frame with one or more layers of metallic material after forming the plurality of dimples.
